(19) United States
(12) Patent Application Publication
(10) Pub. No.: US 2004/0219400 A1
(43) Pub. Date: Nov. 4, 2004

(54) Hybrid fuel cell/desalination systems and method for use

(76) Inventors: Said Al-Hallaj, Chicago, IL (US); Jan Robert Selman, Chicago, IL (US)

Correspondence Address: PAULEY PETERSEN & ERICKSON, 2800 WEST HIGGINS ROAD, SUITE 365, HOFFMAN ESTATES, IL, 60195, US

(21) Appl. No.: 10/762,771

(22) Filed: Jan. 22, 2004

Related U.S. Application Data
(60) Provisional application No. 60/441,784, filed on Jan. 22, 2003.

(51) Int. Cl. H01M 8/04; C02F 1/26

(52) U.S. Cl. 429/13; 429/26; 210/642; 204/518

(57) ABSTRACT

A hybrid system including a fuel cell and a desalination system, such as, for example, a reverse osmosis (RO) system or a thermal desalination process such as a multi-stage flash (MSF) distillation system. The fuel cell generates electricity and thermal energy exhaust which can be used to power and/or increase the energy efficiency of desalination systems. The hybrid system provides improved overall system efficiencies, generally exceeding the typical efficiencies of either fuel-cell power plants or traditional desalination plants. In reverse osmosis systems, for example, heating the salinous water feed with the thermal energy exhaust not only increases the potable water production, but also decreases the relative energy consumption of the desalination system.

### CLAIM OF PRIORITY

This application claims priority to U.S. provisional application Ser. No. 60/441,784, filed on 22 Jan. 2003. The priority provisional application is hereby incorporated by reference herein in its entirety and is made a part hereof, including but not limited to those portions which specifically appear hereinafter.

### FIELD OF THE INVENTION

This invention relates to a hybrid fuel cell/desalination system that typically reduces the cost of seawater desalination by combining fuel cells as a new and environmentally friendly power technology with desalination in a “dual purpose facility,” that simultaneously and efficiently produces electricity and water.

### BACKGROUND OF THE INVENTION

The vast increase in world population and urbanization over the past two decades has resulted in severe potable water and energy shortages. Recent potable water shortages in many parts of the world have cast a spotlight on the problem and led to significant interests in new techniques for water desalination. In addition, environmental concerns over pollutant emissions from conventional power plants using fossil fuel have stimulated research and development in energy technologies that focus on efficient utilization of available energy sources combined with an aggressive search for alternative sources of energy. Current focus is on improving overall energy efficiency of power plants through energy conservation methods, such as cogeneration, and by using highly efficient energy conversion systems, such as fuel cells.

Cogeneration in power plants refers to the simultaneous production of both electric power and useful thermal energy, i.e., heat, from the burning of fuel(s) to produce, for example, steam. The utilization of the thermal energy waste from power plants, either as an alternative source of heat or by increasing power generation via a gas turbine, generally improves the overall energy efficiency of conventional power plants. Cogeneration also generally results in a considerable emission reduction from power plants by minimizing wasted thermal energy in exhaust streams.

In many countries, particularly in Middle Eastern countries, power plants are cogeneration plants that produce electric power and process thermal energy for use in water desalination systems. As will be appreciated, for a given fuel input, the production of water in a cogeneration system is associated with a reduction in electrical power. Although desalination costs have decreased in the last two decades, cost remains a primary factor in selecting a particular desalination technique for drinking water production. Some reduction in desalination costs maybe realized from improvement in plant design, fabrication technique, heat exchange material, plant automation, and scale control techniques. The energy cost for powering desalination systems, such as distillation plants (steam and electricity), often represents at least 40-50 percent of the cost of the produced water. Currently, the minimum cost obtainable for water produced from seawater desalination generally occurs when power and desalination are combined in one “dual purpose facility” that simultaneously produces electricity and water.

Substantial work has been carried out to date on utilizing waste heat from various processes for desalination. Current cogeneration research with respect to desalination systems include studies on humidification-dehumidification desalination processes using waste heat from gas turbines, dual purpose power/multi-stage flash (MSF) and multi-effect distillation (MED) desalination plants based on gas turbines, desalination projects utilizing diesel waste heat, multi-stage flash seawater desalination plants using waste heat from electric-arc furnaces in the steel industry, gas turbine waste heat utilization for distillation systems, vacuum desalination using waste heat from steam turbines, water production by tubular solar stills using waste heat from power plants or chemical industries, and distillation desalination systems powered by waste heat from combined cycle power generation units.

For the typical dual-purpose plant currently producing electricity and water, a realistic estimate of the energy requirement for water production is important as the cost of energy can be combined with equipment, operation and maintenance costs to arrive at the total cost of water production. In typical flash distillation systems, the technology currently being used in most Middle Eastern countries, the desalination process requires both thermal and electrical energy input, and the cost of the total energy requirement accounts for nearly two-thirds of the water production cost. For a given fuel input, the production of water in a dual-purpose plant is associated with a reduction in electricity production; mainly the thermodynamics and design of the dual-purpose plant govern the quantum of this reduction. It is important to estimate this loss of electricity in water production to arrive at the thermal energy cost of water production.

As an example of a desalination system, FIG. 1 shows a typical flash distillation system. Salinous water is heated in a heat exchanger to produce steam in a distillation chamber. The steam rises and condenses to be collected as fresh water. A flash distillation system has particular advantages over other desalination systems, including high reliability, good safety records, the evaporation is from salinous water and not done on a heated surface, the availability of experienced manpower for operation and maintenance, and the capability to produce significant amount of high quality freshwater to meet the ever increasing demand for freshwater with a minimal or insignificant impact on the environment. On the other hand, disadvantages of flash distillation system include a low gain ratio, a high thermal energy input (typically 290 kJ/kg of product water) is required, which puts the flash distillation system process in the highest energy consumption category in comparison with other commercially available desalination processes, and inflexibility in power and water cogeneration systems due to the dependence of flash distillation system on the fixed value of extracted steam (bleeding) from steam turbine.

There is a need for a more efficient and environmentally friendly cogeneration system for use in dual purpose plants that generate electricity and desalinate seawater.

### SUMMARY OF THE INVENTION

A general object of the invention is to provide a hybrid system including a fuel cell and a desalination system for generating electricity and desalinating water.

A more specific objective of the invention is to overcome one or more of the problems described above.

The general object of the invention can be attained, at least in part, through a method for generating electricity and desalinating salinous water. The method includes generating electricity with the fuel cell and powering a desalination system with electricity from the fuel cell to produce fresh water from the salinous water.

The prior art generally fails to disclose fuel cells for powering desalination systems.

The invention further comprehends a hybrid system for generating electricity and desalinating salinous water. The hybrid system includes a fuel cell that generates electricity and thermal energy exhaust and also includes a desalination system powered by the fuel cell.

Fuel cells used in the method and hybrid system of this invention are generally highly efficient (e.g., about 45-60 percent efficient) electrochemical energy conversion devices that convert chemical energy into electricity. High temperature fuel cells known in the art generally produce electricity and high temperature exhaust gases as a byproduct. The fuel cell typically consists of an electrolyte layer in between an anode and a cathode. In a typical fuel cell, gaseous fuels are fed continuously to the anode negative electrode compartment and an oxidant (e.g., oxygen from air) is fed continuously to the cathode (positive electrode) compartment. The electrochemical reactions take place at the electrodes to produce an electric current and heat as a by-product. The exhaust gas temperature depends on the fuel cell type and may range from about 100° C. to about 1000° C.

A variety of different types and sizes of fuel cells are currently in different stages of development for portable and stationary power applications. The hybrid system of this invention incorporates any of the various types and sizes of fuel cells known in the art in combination with a desalination system. Fuel cells can be classified under different categories while the most common classification of fuel cells is by the type of electrolyte used in the cells. Table 1 lists several properties of several commonly available fuel cells useful in the hybrid system and method of this invention. Similar to other electrochemical energy conversion devices, fuel cells are not limited by the Carnot efficiency of thermal engines, as they convert the chemical energy of a fuel directly to electrical energy without intermediate conversion processes.

TABLE 1
Summary of Major Differences of Common Fuel Cell Types

| | Common | | Operating | Charge |
|---|---|---|---|---|
| Fuel Cell Type | Abbreviation | Electrolyte | Temp (° C.) | Carrier |
| Proton | PEFC or PEM | Ion Exchange | 80 | H⁺ |
| Exchange | | Membrane | | |
| Membrane | | | | |
| Alkaline | AFC | Mobilized or | 65-220 | H⁺ |
| | | Immobilized | | |
| | | Potassium | | |
| | | Hydroxide | | |
| Phosphoric | PAFC | Immobilized | 205 | H⁺ |
| Acid | | Liquid | | |
| | | Phosphoric | | |
| | | Acid | | |
| Molten | MCFC | Immobilized | 650 | CO₃⁼ |
| Carbonate | | liquid Molten | | |
| | | Carbonate | | |
| Solid Oxide | SOFC | Ceramic | 800-1000 | O⁼ |
| Fuel Cell | | | | |

The performance of a fuel cell depends on many factors including the electro-catalyst used, the electrode structure, the electrochemical reaction rates, the fuel and oxidant constituents, and the internal resistances. Noble metal electro-catalysts, such as, for example, platinum, are generally required in low temperature fuel cells such as, for example, PEM, PAFC and AFC fuel cells, to achieve practical reaction rates at the anode and cathode. On the other hand, the high temperature fuel cells such as, for example, MCFC and SOFC, typically utilize non-noble metal catalysts such as, for example, nickel, due to the fast electro-kinetics at elevated temperatures. As platinum is easily poisoned by carbon monoxide (CO) resulting from the fuel processing of the hydrocarbon feedstock, PEM and PAFC fuel cells generally have limited tolerances for carbon monoxide, and are mostly suitable to operate with high purity hydrogen at the anode. MCFC and SOFC fuel cells can utilize a variety of hydrocarbon fuels internally without the need for extensive fuel processing. Carbon monoxide is readily converted to hydrogen via water-gas shift reaction in SOFC and MCFC fuel cells, and thus is considered to be equivalent to hydrogen in producing electricity.

Reduction in emissions to the environment is also a major advantage obtained as a result of utilizing fuel cells in the hybrid system of this invention. This also leads to mitigation of green house gas effects. The carbon monoxide (CO), NOₓ and non-methane hydrocarbon (NMHC) emissions from a typical fuel cell are very low (almost negligible) compared with emissions from the typical conventional power generation units. In addition, there are generally no sulfur emissions by a typical fuel cell.

Due to their high efficiency and low level of emissions in comparison with other conventional systems, fuel cells are expected to replace conventional power plants in the near future. As fuel cells are not limited by Carnot cycle efficiency, they have a potential to achieve a level of efficiency beyond 70% when used in a cogeneration facility. Also, combining traditional cycles to fuel cell power systems can significantly reduce the cost of generating electricity. The high operating temperature of MCFC and SOFC, as shown in Table 1, provides an opportunity for using the thermal energy exhaust to make steam for space heating, industrial processing, or in a steam turbine to generate more electricity. The method and hybrid system of one embodiment of this invention uses the thermal energy exhaust to produce fresh water. In another embodiment of this invention, the thermal energy exhaust is used to heat the salinous water to be treated, thereby increasing the efficiency of the desalination system.

One example of a fuel cell available for use in the method and hybrid system of this invention is disclosed in U.S. Pat. No. 6,365,290, issued on 2 Apr. 2000 to Ghezel-Ayagh et al., herein incorporated by reference in its entirety. FIG. 2 shows a fuel cell such as disclosed in U.S. Pat. No. 6,365,290. The fuel cell shown in FIG. 2 is a fuel cell/turbine system that integrates the highly efficient baseline atmospheric pressure direct fuel cell with an unfired Brayton cycle running on the fuel cell waste heat. System analyses have been done using performance projections based on the baseline commercial product assumptions, which are reviewed annually in U.S. Department of Energy studies. Based on these performance assumptions, an efficiency of about 71% has been projected for this system, with 85% of the power coming from the fuel cell section and the balance from the turbine section. System calculations have also been performed with more aggressive fuel cell performance assumptions that indicate that Lower Heating Value (LHV) efficiencies close to 80% are possible in the longer term.

FIG. 2 shows a simplified system diagram for the hybrid fuel cell system. Briefly stated, the fuel cell operates system using fuel and water sent to a heat recovery unit (HRU), where steam is produced and mixed with heated fuel for use as the direct fuel cell fuel gas feed. The direct fuel cell, which can produce about 17 MW, generally operates at about 78 percent fuel utilization, and residual fuel from the anode exit is consumed in an anode exhaust oxidizer. Air is compressed in an intercooled compressor to about 16 atm., heated with system exhaust in the HRU, heated further with exhaust from the anode exhaust oxidizer, and expanded in a turbine. The turbine produces about 3.4 MW net power output. The expanded, low-pressure air leaving the turbine is used as the oxidant in the anode exhaust oxidizer. Flue gas leaving the oxidizer is first cooled by the turbine air, and then sent as the cathode feed gas to the fuel cells. The cathode exhaust gas is sent through the HRU to provide the required pre-heat and water vaporization and then out of the system. The exhaust gas, i.e., thermal energy exhaust of the fuel cell can be used in the method and hybrid system of this invention as described below.

The following operating characteristics have been projected for the hybrid system shown in FIG. 3 using natural gas (volume fraction at 15° C. (59° F.): 96% CH₄, 2% CO₂, 2% N₂) as a fuel source:

### Fuel Cell

DC Power: 17.62 MW

AC Power, Gross: 17.00 MW

### Gas Turbine

Compressor Power: 5.84 MW

Expander Output: 9.28 MW

Net Output: 3.44 MW

Parasitic 0.03 MW

Total Plant Output (AC): 20.41 MW

Plant Exhaust Temperature=98.1° C. (208.6° F.)

Overall LHV Efficiency: 71.08%.

The fuel cell system in FIG. 3 provides many advantages. The system meets the U.S. Department of Energy's goal of Lower Heating Value (LHV) efficiency above 70 percent. The heat exchange temperature has been reduced to less than 871.1° C. (1600° F.), which is in the range of commonly available high temperature heat exchange materials. The Brayton cycle is an unfired system, indirectly heated with fuel cell waste heat, which yields the highest efficiency, as all primary fuel consumption is done in the fuel cell, which is the more efficient portion of the system. All fuel and oxidant supply is accomplished with the 15 psig natural gas pressure and the air compressor associated with the turbine equipment. High efficiency is obtained without the use of an additional steam bottoming cycle, eliminating the need for high-pressure boilers (a concern with respect to unattended operation). The system allows the turbine pressure ratio to be set independently of fuel cell pressure considerations. Although in normal hybrid operation the turbine will be unfired, a burner could be provided in the turbine to allow independent operation of the turbine, replacing the existing fuel cell startup burner. Conceptually, the turbine section could be producing power during the fuel cell startup. In principle, the turbine section could be used to load follow, utilizing stored kinetic energy, while the fuel cell is efficiently operated at constant power. This is only possible because of the decoupled nature of the fuel cell and turbine sections of the plant.

### BRIEF DESCRIPTION OF THE DRAWINGS

The above-mentioned and other features and objects of this invention will be better understood from the following detailed description of preferred embodiments taken in conjunction with the drawings.

FIG. 1 is a flash distillation system known in the art and available for use in the hybrid system according to one embodiment of this invention.

FIG. 2 is a fuel cell such as disclosed in U.S. Pat. No. 6,365,290 and that is available for use in the hybrid system according to another embodiment of this invention.

FIG. 3 is a fuel cell according to another embodiment of this invention.

FIG. 4 is a hybrid fuel cell/desalination system according to yet another embodiment of this invention.

FIG. 5 is a hybrid fuel cell/desalination system according to yet another embodiment of this invention.

FIG. 6 is a hybrid fuel cell/desalination system according to still yet another embodiment of this invention

### DETAILED DESCRIPTION OF THE PRESENTLY PREFERRED EMBODIMENTS

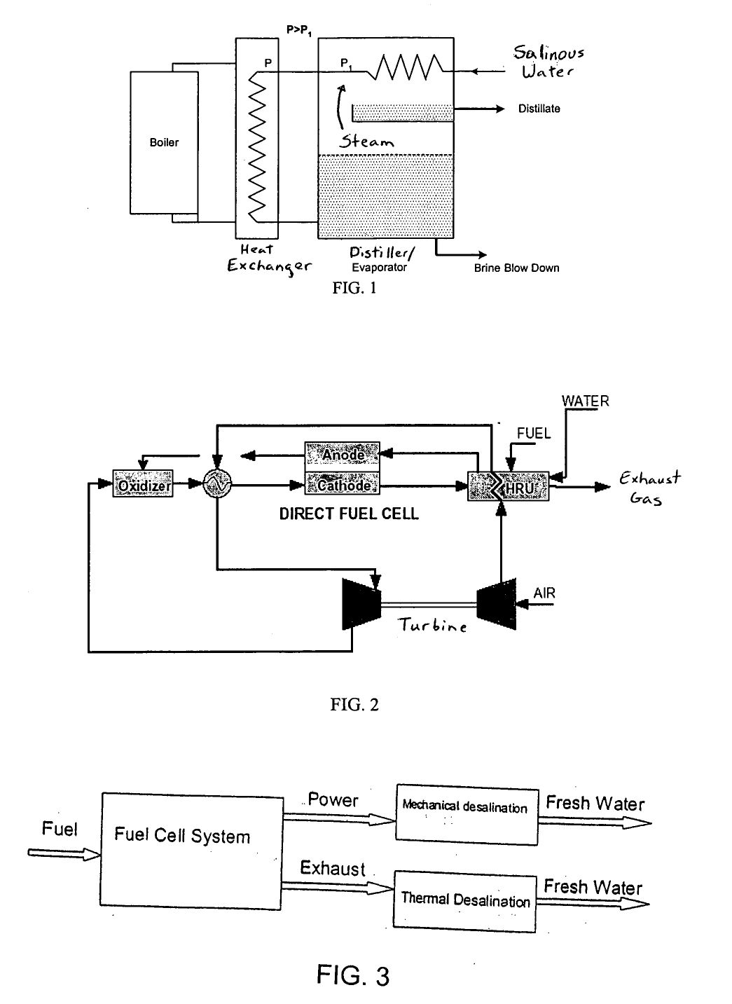

The present invention relates to a method for generating electricity and desalinating salinous water, as well as a hybrid system through which the method is accomplished. The method of this invention includes generating electricity by a fuel cell, such as known in the art, and powering a desalination system for producing fresh water from salinous water. As shown in FIG. 3, the fuel cell can power mechanical desalination systems, such as, for example, reverse osmosis (RO) or other membrane-based systems, with a portion of electricity generated by the fuel cell, or the fuel cell can power thermal desalination systems using thermal energy exhaust from the fuel cell, such as, for example, in flash distillation systems such as shown in FIG. 1, multi-source flash distillation systems (MFS), multi-effect distillation systems (MED), and vapor compression systems (VC). As used herein, “salinous water” refers to any water including undesirable amounts of salt for consumption or other use by humans, such as, without limitation, sea water or brackish water.

Thermal energy exhaust, such as in a form of high temperature exhaust gas, is produced as a byproduct of generating electricity with a typical fuel cell. In one embodiment of this invention, the thermal energy exhaust is used to heat the salinous water to produce heated salinous water. The heated salinous water can be used to produce fresh water. Particular desalination systems, such as multi-source flash distillation techniques, require thermal energy to produce fresh water, such as, for example, through the production of steam. Other desalination systems, such as reverse osmosis systems, do not require the salinous water to be heated, although heated salinous water can increase the efficiency of the desalination system.

The thermal energy of the fuel cell exhaust can be transferred to the salinous water feeding into the desalination system by any heat exchanging means known in the art. In one embodiment of the invention, both the thermal energy exhaust and the salinous water are introduced in a heat exchanger to heat the salinous water within the heat exchanger.

In one particularly preferred embodiment of this invention, steam is produced by heating the salinous water. The steam can be produced in or introduced into an evaporator/distillation chamber, such as shown in FIG. 1, where the steam is condensed to produce fresh water. The steam can be condensed using a cold, preheated salinous water carrying portion of the salinous water feed line that extends through the distillation chamber. The fresh water condensate is collected and used as needed.

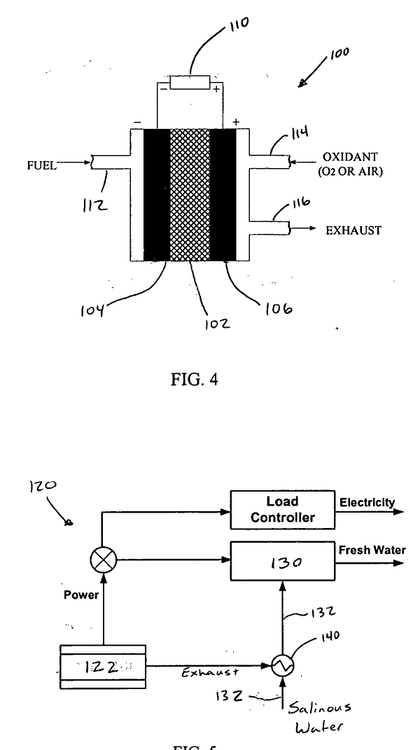

FIG. 4 shows a fuel cell 100 useful in the hybrid system of this invention to produce electricity and power a desalination system. The fuel cell 100 includes an electrolyte layer 102 disposed between two porous electrodes. One of the two porous electrodes is an anode 104 and the other of the two porous electrodes is a cathode 106. As will be appreciated by one skilled in the art following the teachings herein provided, anode 104 and the cathode 106 are connected to oppositely charged terminals of an electric load 110. The anode is connected to a negative terminal of the electric load 110 and the cathode is connected to a positive terminal of the electric load 110.

Fuel is introduced to the anode 104 by fuel line 1112. The fuel can be liquid or gaseous. In one embodiment of this invention, the fuel is used to produce hydrogen ions at the anode 104. As will be appreciated by one skilled in the art following the teachings herein provided, the fuel can be any fuel available for use in fuel cells. Examples of suitable fuels include hydrogen and hydrocarbons such as, without limitation, natural gas, diesel fuel, methanol, and ethanol, as well as combinations thereof. As will also be appreciated, hydrocarbon fuel can used to produce hydrogen for the electrochemical reaction by either internal reforming or external reforming methods, such as known in the art. Internal reforming can be accomplished by the anode or by a reformer unit integral with the fuel cell system. External reforming can be accomplished by an external reformer unit such as known and available in the art.

An oxidant, such as oxygen gas or air, is introduced to the cathode through oxidant line 114. The oxidant reacts with the hydrogen ions from the anode to electrochemically generate electricity. Byproducts of the electrochemical reaction exit the fuel cell 100 through an exhaust line 116. Byproducts of the electrochemical reaction include water, such as in the form of steam, and thermal energy.

FIG. 5 shows a hybrid system 120 for generating electricity and desalinating salinous water. The hybrid system 120 includes a fuel cell 122, such as the fuel cell 100 shown in FIG. 5 or the fuel cell disclosed in U.S. Pat. No. 6,365,290, previously incorporated by reference, for generating electricity by electrochemical reaction. The fuel cell 122 can be any type of fuel cell known in the art including, without limitation, proton exchange membrane fuel cells, alkaline fuel cells, phosphoric acid fuel cells, molten carbonate fuel cells, solid oxide fuel cells, and combinations thereof. As discussed above, fuel and an oxidant are introduced to the fuel cell and the fuel cell electrochemically generates electricity and thermal energy exhaust.

The hybrid system shown in FIG. 5 includes a desalination system 130 powered by the fuel cell 122. The desalination system 130 is a water treatment system that produces fresh water, i.e., drinkable water, from salinous water. The desalination system 130 shown in FIG. 5 is a reverse osmosis desalination system. Reverse osmosis desalination systems known in the art typically pump water through a membrane, wherein the water passes through the membrane, but impurities do not. As will be appreciated by one skilled in the art following the teachings herein provided, various other desalination systems known in the art are available for use in the method and hybrid system of this invention, such as, for example, electrodialysis desalination systems, multi-effect distillation desalination systems, mechanical vapor compression desalination systems, thermal vapor compression desalination systems, multi-stage flash desalination systems, humidification-dehumidification desalination systems, and combinations thereof. The desalination system 130 receives salinous water from a salinous water feed line, represented by arrow 132, and, by a reverse osmosis technique such as is known in the art, produces fresh water.

The hybrid system 120 includes a heat exchanger 140 connected to the fuel cell 122 to receive the thermal energy exhaust. The salinous water feed line 132 transfers unheated salinous water to the heat exchanger 140. The heat exchanger 140 heats the salinous water using the thermal energy exhaust from the fuel cell 122. The salinous feed line then transfers the heated salinous water from the heat exchanger to the desalination system 130 connected to the salinous water feed line. As discussed above, the desalination system 130 removes salt or brine from the heated salinous water, thereby providing fresh water for human use and/or consumption.

As will be appreciated, the reverse osmosis desalination system 130 will also produce fresh water without heating the salinous water, and thus this invention is not intended to be limited to treating only heated salinous water. However, it is known that the temperature of the salinous water introduced into the reverse osmosis system influences the fresh water production efficiency. It has been shown that an 8 percent reduction in energy consumption by a reverse osmosis system can be achieved by increasing the salinous feed water temperature from 20° C. to 28° C. Also, as the temperature of the salinous feed water increases it results in an increase in the potable water production. The hybrid system and method of this invention thus have the power efficiency and environmental advantages of a fuel cell while providing a more efficient desalination system.

In addition, fuel cells have a tendency to work more efficiently when subjected to constant loads. However, the demand for electricity and water will not be constant throughout the day or during the year, and thus it is desirable to have a robust, flexible system which alternates between the production of water and the supply of electricity as needed while operating the fuel cell at optimum conditions. The hybrid system and method of this invention can provide such flexibility, allowing the fuel cells to be operated at the most efficient levels.

As the demand for electricity is not typically constant throughout the day, the hybrid system 120 will be producing electricity during peak times and off-peak times of electricity usage and demand. During the off-peak times, the demand for electricity is relatively lower, and under such situations the load on the reverse osmosis process could be proportionately increased to increase fresh water production. Typical electricity consumption of reverse osmosis plants is in the range of about 4 to 7 kWh/m³ depending on conditions such as the water salinity, the recovery ratio, the required permeate quality, the plant configuration, and implementation of energy recovery in the brine blow down.

During peak times the demand for electricity is relatively high. At such times the hybrid system 120 can be used to produce additional electricity while reducing the amount of fresh water produced. The amount of electricity supplied to the desalination system 130 could be reduced or stopped and redirected to an electrical grid for distribution. If the desalination system 130 remains operational, but at a lower production, the thermal energy exhaust can still be used to increase the production efficiency of the desalination system 130 as discuss above. In another embodiment of the invention, the thermal energy exhaust can be redirected from the heat exchanger 140 to be used as is known in other current cogeneration systems, such as for producing additional electricity. Thus, by altering the electrical loads to the desalination system 130, the process of either supplying electricity or producing water alternatively can be easily controlled according to demand.

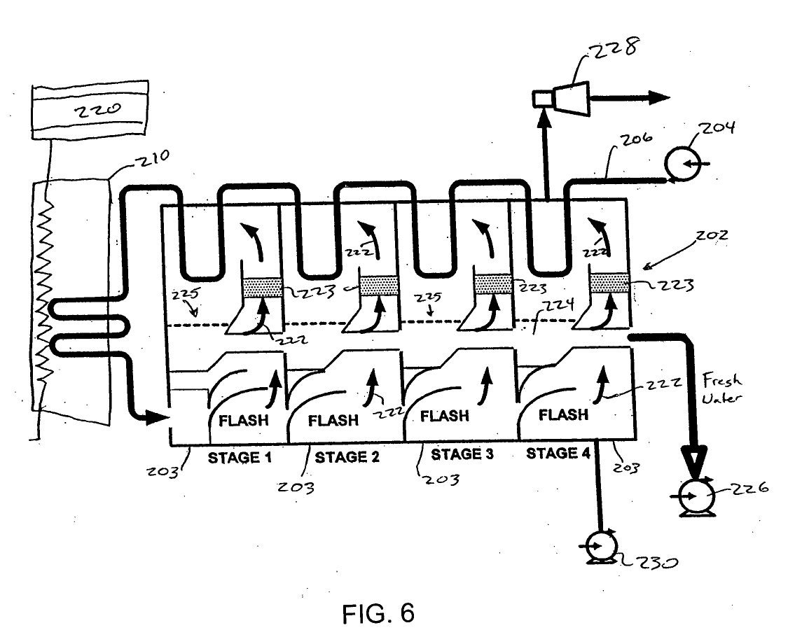

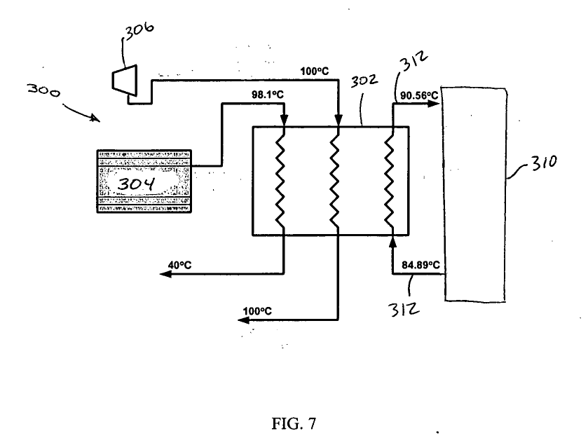

In another embodiment of this invention, the desalination system incorporates distillation (evaporation/condensation) techniques to produce fresh water. FIG. 6 shows a hybrid system 200 that can be used as the desalination system of the hybrid system of this invention. The hybrid system 200 includes a multi-source distillation system 202 having four flash distillation chambers 203. A feed-water pump 204 pumps salinous water through a salinous water feed line represented by arrow 206. The water feed line extends through each of the distillation chambers 203 before entering a heat exchanger 210. The heat exchanger 210 receives thermal energy exhaust from the fuel cell 220 to heat the salinous water in the salinous water feed line. The heated salinous water is introduced into the four distillation chambers where steam, represented by arrows 222, rises to contact the “cold” salinous water feed line. Mist separators 223, as known in the art, can be used to further extract any remaining brine or salt from the steam. The steam condenses due to the lower temperature of the salinous water feed line, collects as fresh water 224 in a collection trough 225, and is pumped out by water pump 226. A vent ejector 228 is used to reduce the pressure within the distillation chambers 203 and a brine pump 230 is used to remove the leftover salinous water from the distillation chambers 203.

In one embodiment of this invention, the hybrid system can replace current desalination systems powered by non-fuel cell power sources. In other words, the non-fuel cell power sources are be replaced by, or substituted with, a fuel cell according to the present invention. In another, particularly preferred embodiment of this invention, the hybrid system is added to existing desalination systems powered by non-fuel cell sources, and the fuel cell acts as an additional, or supplemental, power source for generating electricity and heating salinous water. For example, the method of this invention can be incorporated into an existing desalination system, such as, for example, a multi-source flash distillation system using steam turbines, to form a hybrid system according to this invention. FIG. 7 shows a hybrid system 300 of this invention incorporating a presently used steam turbine powered multi-source flash distillation system. The hybrid system 300 includes a heat exchanger 302 connected to both a fuel cell 304 and a steam turbine 306.

A desalination system 310 is a multi-stage flash distillation system in combination with a salinous water feed line, represented by arrows 312, extending through the heat exchanger 302. Steam from the steam turbine 306 and the thermal energy exhaust from the fuel cell 304 together heat the salinous water in the heat exchanger 302. When added to an existing steam turbine multi-source flash distillation system, the thermal energy exhaust from the fuel cell replaces some of the steam feed requirement from the steam turbine. Therefore, the effective result is an increase in power generation from the steam turbine 306 while improving the overall efficiency of the system. As discussed in an article entitled “Conceptual design of a novel hybrid fuelcell/desalination system,” by Al-Hallaj et al. and accepted for publication in Desalination on 10 Sep. 2003 (Proof DES 2599), herein fully incorporated by reference in its entirety, overall efficiency improvements of at least about 5 percent can be obtained by incorporating the method and hybrid system of this invention in an existing desalination system.

Thus, the invention provides a hybrid system combining a fuel cell with a desalination system. The hybrid system and method of this invention efficiently generate electricity while producing fresh water.

While the embodiments of the invention described herein are presently preferred, various modifications and improvements can be made without departing from the spirit and scope of the invention. The scope of the invention is indicated by the appended claims, and all changes that fall within the meaning and range of equivalents are intended to be embraced therein.

What is claimed is:

1. A method for generating electricity and desalinating salinous water, the method comprising:
generating electricity with a fuel cell; and
powering a desalination system with electricity from the fuel cell to produce fresh water from the salinous water.

2. The method according to claim 1, wherein the salinous water is selected from a group including brackish water, sea water, and combinations thereof.

3. The method according to claim 1, wherein the desalination system is selected from the group including electrodialysis desalination systems, reverse osmosis desalination systems, multi-effect distillation desalination systems, mechanical vapor compression desalination systems, thermal vapor compression desalination systems, multi-stage flash desalination systems, humidification-dehumidification desalination systems, and combinations thereof.

4. The method of claim 1, additionally comprising:
producing thermal energy exhaust as a byproduct of generating electricity with the fuel cell;
heating the salinous water with the thermal energy exhaust to produce heated salinous water; and
producing fresh water from the heated salinous water.

5. The method of claim 4, additionally comprising:
introducing the thermal energy exhaust into a heat exchanger;
introducing the salinous water into the heat exchanger; and
heating the salinous water in the heat exchanger.

6. The method of claim 5, additionally comprising producing steam from the salinous water and condensing the steam to produce the fresh water.

7. The method of claim 6, wherein the fresh water is produced by multi-stage flash distillation.

8. The method of claim 6, additionally comprising:
introducing the heated salinous water into a distillation chamber;
producing steam in the distillation chamber;
condensing the steam in the distillation chamber to produce fresh water.

9. The method of claim 6, wherein a salinous water feed line extends through the distillation chamber and the steam is condensed using the salinous water feed line.

10. The method of claim 7, wherein a portion of the generated electricity powers the multi-stage flash desalination.

11. The method of claim 5, additionally comprising introducing the heated salinous water into a reverse osmosis system.

12. The method of claim 11, wherein a portion of the generated electricity powers the reverse osmosis system.

13. The method of claim 12, wherein the thermal energy exhaust heats the salinous water during a first predetermined period and during a second predetermined period the thermal energy exhaust generates additional electricity.

14. The method of claim 1 wherein the fuel cell produces electricity by electrochemical reaction.

15. The method of claim 14, wherein the fuel cell comprises an electrolyte layer between two porous electrodes.

16. The method of claim 15, wherein one of the two porous electrodes is an anode and the other of the two porous electrodes is a cathode.

17. The method of claim 16, additionally comprising:
introducing a fuel to the anode; and
introducing an oxidant to the cathode;
wherein electricity is formed at the anode and cathode.

18. The method of claim 17, wherein the fuel is selected from a group including of hydrogen, hydrocarbons, and combinations thereof.

19. The method of claim 18, wherein the fuel is selected from a group including natural gas, diesel fuel, methanol, ethanol, and combinations thereof.

20. The method of claim 19, wherein hydrogen is produced by the hydrocarbon fuel by one of internal reforming and external reforming.

21. A hybrid system for generating electricity and desalinating salinous water, comprising:
a fuel cell, wherein the fuel cell generates electricity and thermal energy exhaust; and
a desalination system powered by the fuel cell.

22. The hybrid system of claim 21, wherein the fuel cell is selected from a group including proton exchange membrane fuel cells, alkaline fuel cells, phosphoric acid fuel cells molten carbonate fuel cells, solid oxide fuel cells, and combinations thereof.

23. The hybrid system of claim 21, additionally comprising:
a heat exchanger connected to the fuel cell to receive the thermal energy exhaust;
a salinous water feed line in combination with the heat exchanger, wherein the salinous water feed line is adapted to transfer unheated salinous water to the heat exchanger and to transfer heated salinous water from the heat exchanger; and
a desalination system connected to the salinous water feed line, the desalination system adapted to remove salt or brine from the heated salinous water.

24. The hybrid system of claim 21 wherein the fuel cell produces electricity by electrochemical reaction.

25. The hybrid system of claim 21, wherein the fuel cell comprises an electrolyte layer between two porous electrodes.

26. The hybrid system of claim 25, wherein one of the two porous electrodes is an anode and the other of the two porous electrodes is a cathode.

27. The hybrid system of claim 21, wherein the desalination system comprises a reverse osmosis system.

28. The hybrid system of claim 21, wherein the desalination system comprises a flash distillation system.
